(19) United States
(12) Patent Application Publication
(10) Pub. No.: US 2008/0292749 A1
(43) Pub. Date: Nov. 27, 2008

(54) Aromatization of a Milk Product Using at Least One Bacterium Producing a Bacteriocin and Belonging to the Pediococcus Genus

(76) Inventors: Jonathan Goodwins, Abilly (FR); Annie Mornet, Mondion (FR); Elise Manoury, Chatellerault (FR)

Correspondence Address: FROST BROWN TODD, LLC, 2200 PNC CENTER, 201 E. FIFTH STREET, CINCINNATI, OH, 45202, US

(21) Appl. No.: 10/577,351

(22) PCT Filed: Oct. 27, 2004
(86) PCT No.: PCT/FR03/12807

§ 371 Date: Oct. 16, 2006

(30) Foreign Application Priority Data
Oct. 31, 2003 (FR) 0312807

(51) Int. Cl. A23C 9/123; A23C 9/127; A23C 19/032

(52) U.S. Cl. 426/40; 426/43

(57) ABSTRACT

The invention relates to the use of at least one bacteria producing a bacteriocin and belonging to the Pediococcus genus for aromatizing a milk product.

The present invention relates to the use of at least one bacterium producing a bacteriocin and belonging to the genus Pediococcus to aromatize a milk product.

Manufacturing milk products requires the use of different micro-organisms having specific roles in food technology.

In particular, lactic bacteria are used to acidify milk, which causes the milk to ferment into curd. When lactic bacteria are concerned, we speak of ferments or starters.

Other micro-organisms are used to ripen cheeses. In this case, we speak of ripening flora or non-starters. Such micro-organisms can transform the curd into a partially lipolyzed, proteolyzed product enriched in aromatic compounds, such as amino acids or fatty acids. The most generally used ripening agents are those from the genii Arthrobacter, Candida, Corynebacterium, Debaryomyces, Geotrichum, Kluyveromyces, Lactobacillus, Lactococcus, Leuconostoc, Micrococcus, Pediococcus, Propionibacterium, Rhodotorula, Saccarormyces, Staphylococcus, Streptococcus or Penicillium, such as Penicillium roqueforti to ripen Roquefort.

Ripening is very important in endowing the milk product with flavour.

Adding traditional ripening agents to acidification ferments, however, is sometimes not sufficient when developing the desired flavour in the milk product. Traditional ripening agents do not always act properly during the ripening process and cannot sufficiently aromatize the milk product, in particular when the ripening period is short or reduced. In this case, the desired aromatic profile is not obtained and other unwanted flavours may appear, for example bitterness.

Thus, to satisfy industrial requirements, it has become necessary to find novel micro-organisms which can ripen and aromatize milk products.

The problem which the present invention intends to solve is the provision of a means for aromatizing milk products in a significant and rapid manner.

To this end, the invention proposes the use of at least one bacterium producing a bacteriocin and belonging to the genus Pediococcus to aromatize a milk product.

The use of at least one bacterium producing a bacteriocin and belonging to the genus Pediococcus can advantageously inhibit unwanted wild floras by competition, which flora usually develop in an opportunistic manner.

A further advantage of the present invention lies in the fact that the bacterium producing a bacteriocin and belonging to the genus Pediococcus may be used jointly with bacteria used to acidify a milk product, i.e. with ferments or bacteria known as starters.

Advantageously, the use of at least one bacterium producing a bacteriocin and belonging to the genus Pediococcus can aromatize the milk product without changing the technology used to manufacture the milk product or changing the parameters of the acidification kinetics for the milk product, for example.

Finally, using at least one bacterium producing a bacteriocin and belonging to the genus Pediococcus can produce a milk product ripened in a significant manner, with no bad flavours or bad odours.

The expressions “ripened in a significant manner” or “aromatized in a significant manner” mean that they differ with respect to a conventionally ripened milk product.

The invention enjoys the further advantage of allowing the milk product to be ripened at a temperature which is higher than traditional ripening temperatures, such as at a temperature in the range 4° C. to 15° C., and preferably in the range 4° C. to 10° C. for Cheddar.

A further advantage of the present invention is that the rate of ripening can be increased to obtain a significant aromatic profile even after 6 months of ripening, sometimes 4 months of ripening, in particular for Cheddar.

Other advantages and characteristics of the invention will become apparent from the following description and examples which are given by way of non-limiting illustration.

The invention concerns the use of at least one bacterium producing a bacteriocin and belonging to the genus Pediococcus to aromatize a milk product.

The genus Pediococcus belongs the Streptococaceae family. Bacteria belonging to this genus are gram-positive bacteria, and generally catalase-negative, homofermentary and producing D or L lactate from carbohydrates.

Bacteria from the genus Pediococcus are naturally present in milk and widely used in the food industry, in particular the meat industry, as they provide texture and inhibit undesirable flora, including pathogenic flora, in butchery products.

The bacterium belonging to the genus Pediococcus is selected from the following species: Pediococcus acidilactici, Pediococcus pentosaceus, Pediococcus damnosus, Pediococcus halophiles, Pediococcus parvulus, and Pediococcus urinae-equi.

The species Pediococcus cerevisiae has been reclassified into the species Pediococcus acidilactici.

Preferably, the bacterium used in accordance with the invention is the bacterium Pediococcus acidilactici deposited with the CNCM [Collection Nationale de cultures de Microorganismes, National Collection of Micro-organism Culture] on 20^{th} Oct. 2003 in the name of Rhodia Chimie, 26 quai Alphonse Le Gallo, 92512 Boulogne-Billancourt, with accession number CNCM I-3113.

Advantageously, the bacterium producing a bacteriocin and belonging to the genus Pediococcus may be associated with at least one bacterium which is sensitive to said bacteriocin.

The expression “sensitive to bacteriocin” means a bacterium which may be killed or lyzed or its growth slowed or stopped by the presence and/or action of said bacteriocin.

The term “bacteriocin” means a peptide substance secreted by lactic bacteria and having bactericidal or bacteriostatic properties as regards various foreign bacteria termed “sensitive” bacteria.

Advantageously, the bacteria producing a bacteriocin and belonging to the genus Pediococcus may be associated with at least one bacterium sensitive to said bacteriocin selected from lactic bacteria from the genii Lactococcus, Lactobacillus, Pediococcus, Leuconostoc and Streptococcus.

Bacteria belonging to the genus Pediococcus belong to the group of bacteria known as NSLAB (non starter lactic acid bacteria) which are lactic bacteria which do not significantly contribute to acidification.

The use of at least one bacterium producing a bacteriocin and belonging to the genus Pediococcus can result in a marked aromatic intensity in milk products, as well as more marked sweet and brothy characteristics and significantly reduced bitterness compared with the same milk product produced without adding said bacterium.

The aromatized milk product of the invention may also be fermented milk.

Preferably, the milk product of the invention comprises milk of animal and/or vegetable origin.

Milk of animal origin which may be cited includes cow's milk, sheep's milk, goat's milk, camel's milk and buffalo milk.

Milk of vegetable origin which may be cited includes any fermentable substance of vegetable origin which may be used in accordance with the invention, in particular that from soya grain, rice, coconut or malt.

Examples of aromatized milk products of the invention which may be cited include soft cheeses, uncooked pressed cheeses, cooked cheeses, Mozzarella type cheeses, fresh cheeses, blue cheeses, processed chesses or cottage cheese, as well as yogurt, matured cream, milk drinks, milk by-products or baby milk.

Examples of aromatized cheeses of the invention which may be cited include Banon, Bleu d'Auvergne, Brie, Boulette d'Avesne, Caerphilly, Camembert, Cantal, Carre de l'Est, Chanco, Chaource, Cheddar, Cheshire, Cotija, Coulommiers, Danbo, Dauphin, Double Gloucester, Edam, Emmental, Epoisse, Feta, Gorgonzola, Gouda, Jarlsberg, Limburger, Livarot, Mimolette, Manchego, Maroilles, Monterey Jack, Mozzarella, Munster, Parmesan, Pélardon, Pont l'Evêque, Raclette, Red Leicester, Roquefort, Saint-Félicien, Saint-Marcellin, Saint-Nectaire, Saint-Paulin, Stilton, Tilsiter, Tomme de Savoie, Vacherin Mont d'Or and Vieux-Lille.

The bacterium of the invention is used by the skilled person in a conventional manner to aromatize a milk product. When manufacturing a milk product, this is carried out as is normal practice in this field, in particular by fermentation of a milk product by incorporating a ferment.

In particular, it is possible to mix at least one bacterium producing a bacteriocin and belonging to the genus Pediococcus directly with lactic ferments or the ferment used to manufacture the milk product. In this case, the bacterium of the invention may be mixed with lactic ferments or the ferment in the liquid or solid state and in its dry, freeze dried or frozen condition. The bacterium of the invention may also be used during the step for acidification of the milk product or it may be added during manufacture.

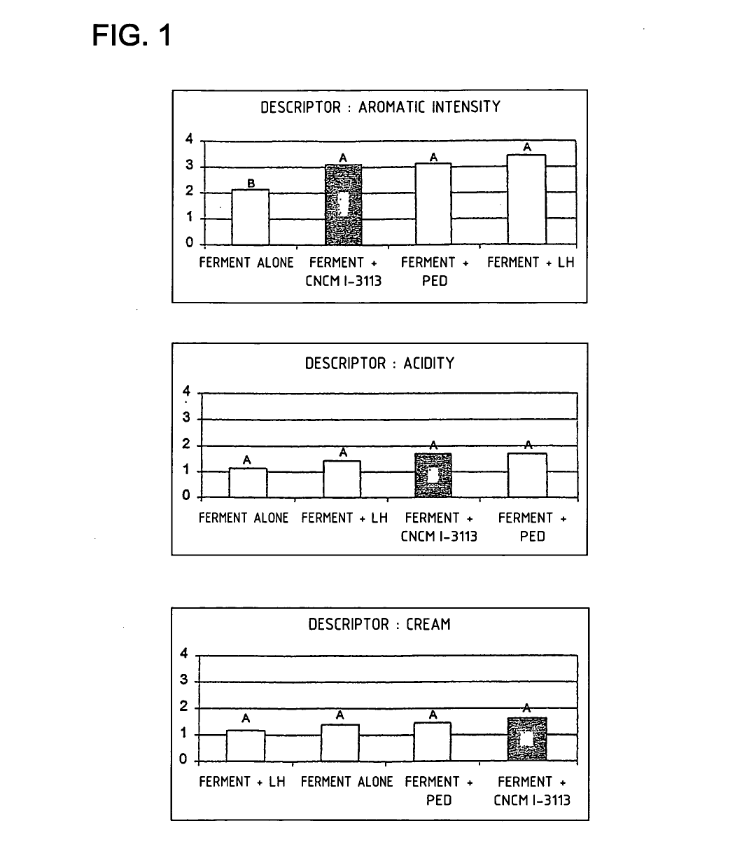

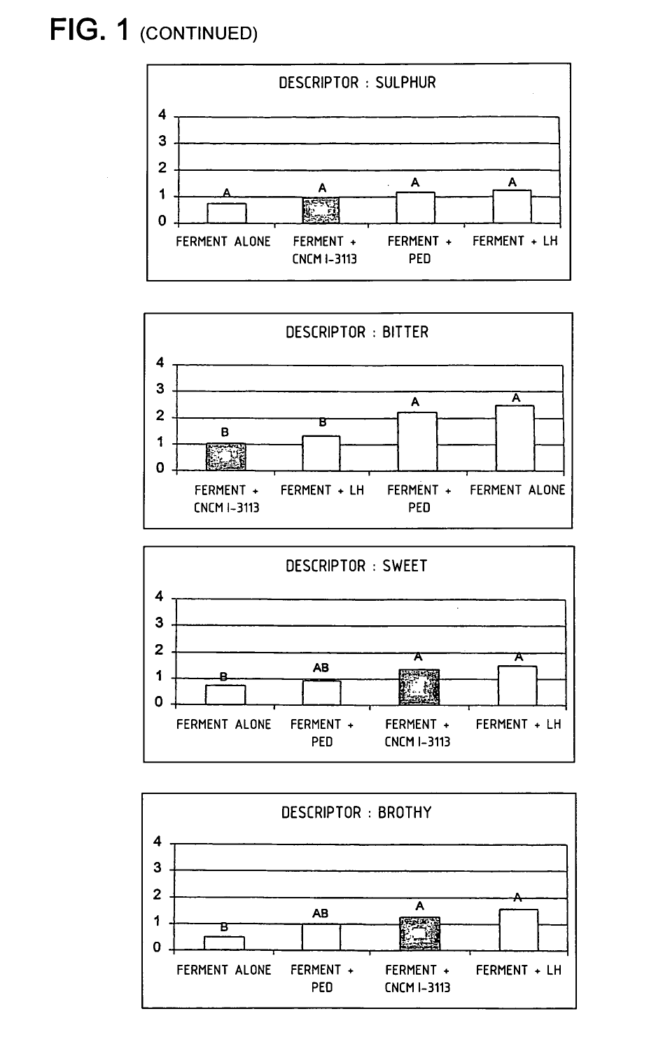

FIG. 1 shows the means of the scores obtained for the flavour descriptors for each of the Cheddar type cheeses of the study. Interpretation of the results of the Newman-Keuls test: the difference between Cheddar type cheeses connected by the same letter is not significant.

The following examples illustrate the invention without in any way limiting its scope.

### EXAMPLE

Sensorial characterization of ferment associated with the bacterium CNCM I-3113, and comparison with the ferment alone and with the ferment associated with either a Lactobacillus helveticus (LH) bacterium or with another bacterium, Pediococcus pentosaceus (PED), not producing a bacteriocin.

### Preparation of Cheddar Type Cheese:

Milk was reconstituted from skimmed milk powder and calcium chloride (35 ml of a solution of Calciol Marsha110, 500 g/l per 100 litres of milk). The time to dissolve the powders was about 30 minutes. This milk was stored for 24 hours at 10° C.

Next, a quantity of cream was added to obtain a composition with a fat content of 44 grams per litre of milk as well as an acidification ferment in an amount of 2.10×10⁶ cfu/ml (colony forming units) and the test strain (either the CNCM I-3113 strain or LH or PED) in an amount of about 10×10⁶ cfu/ml at 32° C. in a mini-cell. Rennet with a chymosin content of 520 mg of chymosin/litre of rennet was added to the milk in an amount of 25 ml of rennet/100 litres of milk. The pH was monitored during manufacture using a KNICK PORTAMESS® pH meter and a Mettler Toledo batch 406-M6-DXK-S7/25 pH penetration electrode. The coagulation time was about 60 minutes.

The curd obtained was cut. The curd and whey were heated to 40° C. The whey formed was removed. When the pH of the curd reached 5.20, the curd was salted with 3% NaCl expressed as the mass with respect to the finished product. The curd was then placed in moulds and pressed.

The Cheddar type cheeses produced were placed under impermeable sheets for 24 hours following inoculation by the ferment and placed in a ventilated tank at 8° C. to await sensorial analysis 6 months later.

### Sensorial Analysis:

The Cheddars obtained were evaluated by sensorial analysis after storing for 6 months at 8° C. The quantitative descriptive analysis of Cheddars kept at an optimal sampling temperature of 14° C., was carried out by a panel of 15 experts on a non structured linear scale of 0 to 6 points. This sensorial profile analysis was duplicated at intervals of several days. The panellists, who had been selected and trained, carried out their evaluation using 7 flavour descriptors: aromatic intensity, acidity, sulphur, cream, sweet, bitter and brothy. The sensorial differences were evaluated by a two factor, fixed model variance analysis (ANOVA) using the mean Newman-Keuls comparison test with an alpha threshold of 5% for each of the descriptors. The software used for these statistical analyses were Fizz® (Biosystems) and Statgraphics®.

The data concerning the Cheddar cheese obtained with the ferment supplemented with the I-3113 CNCM bacterium were compared with those of Cheddars obtained with the ferment alone and the ferment supplemented with other reference bacteria (LH or PED). The mean values obtained for the flavour descriptors are indicated in Table 1 and the significant differences resulting from the ANOVA and the mean comparison test are shown in Table 2 and FIG. 1.

TABLE 1
Mean scores attributed by sensorial analysis panel for Cheddars obtained
with the various test bacteria for the flavour descriptors.

| | Aromatic | Acid- | | Sul- | Bit- | | |
|---|---|---|---|---|---|---|---|
| Cheddars | intensity | ity | Cream | phur | ter | Sweet | Brothy |
| Ferment | 2.13 | 1.13 | 1.39 | 0.75 | 2.48 | 0.73 | 0.50 |
| alone | | | | | | | |
| Ferment + | 3.10 | 1.70 | 1.61 | 0.96 | 1.01 | 1.37 | 1.25 |
| CNCM | | | | | | | |
| I-3113 | | | | | | | |
| Ferment + | 3.42 | 1.42 | 1.16 | 1.22 | 1.31 | 1.50 | 1.57 |
| LH | | | | | | | |
| Ferment + | 3.15 | 1.70 | 1.44 | 1.18 | 2.23 | 0.91 | 1.00 |
| PED | | | | | | | |

TABLE 2
Comparison of means for each of the flavour descriptors using the
Newman-Keuls 5% test. Interpretation of results: the difference between
Cheddars connected by the same letter is not significant.

| | Aromatic | Acid- | | Sul- | Bit- | | |
|---|---|---|---|---|---|---|---|
| Cheddars | intensity | ity | Cream | phur | ter | Sweet | Brothy |
| Ferment | B | A | A | A | A | B | B |
| alone | | | | | | | |
| Ferment + | A | A | A | A | B | A | A |
| CNCM | | | | | | | |
| I-3113 | | | | | | | |
| Ferment + | A | A | A | A | B | A | A |
| LH | | | | | | | |
| Ferment + | A | A | A | A | A | AB | AB |
| PED | | | | | | | |

FIG. 1 shows a histogram of the results obtained in Tables 1 and 2: Graphical representations of the means of the scores obtained for the flavour descriptors for each of the Cheddar cheese types of the study. Interpretation of the results of the Newman-Keuls test: the difference between the Cheddar type cheeses connected by the same letter is not significant.

Adding the CNCM I-3113 bacterium considered to be aromatizing can significantly modify the organoleptic properties of the Cheddar compared with the Cheddar with the ferment alone or the Cheddar with the ferment supplemented with the PED bacterium. The Cheddar containing the ferment supplemented with the CNCM I-3113 bacterium differed from the Cheddar containing the ferment alone in that it had an aromatic intensity, a sweet flavour and a brothy aroma which was significantly more pronounced and it developed significantly less bitterness. The Cheddar containing the ferment supplemented with the CNCM I-3113 bacterium differed from the Cheddar containing the ferment supplemented with the PED bacterium in that it was significantly less bitter. The Cheddar manufactured in accordance with the invention also had an aromatic profile which was not significantly different from that manufactured with the ferment supplemented with the LH strain.

1-8. (canceled)

9. A method for aromatizing a milk product comprising the addition to said milk product during manufacture of at least one bacterium producing a bacteriocin and belonging to the genus Pediococcus.

10. The method according to claim 9 wherein the bacterium belonging to the genus Pediococcus acidilactici, Pediococcus pentosaceus, Pediococcus damnosus, Pediococcus halophiles, Pediococcus parvulus, and Pediococcus urinae-equi, and combinations thereof.

11. The method according to claim 10 wherein the bacterium belonging to the genus Pediococcus is the bacterium Pediococcus acidilactici deposited at the CNCM on Oct. 20, 2003, in the name of Rhodia Chemie, 26 quai Alphonse de Gallo, 92512 Boulogne-Billancourt, France, with accession number 1-3113.

12. The method according to claim 9 wherein the bacterium belonging to the genus Pediococcus is associated with at least one bacterium which is sensitive to said bacteriocin.

13. The method according to claim 9 wherein the bacterium belonging to the genus Pediococcus is associated with at least one bacterium which is sensitive to said bacteriocin selected from lactic bacteria from the genii Lactococcus, Lactobacillus, Pediococcus, Leuconastoc and Streptococcus.

14. The method according to claim 9 wherein the milk product is fermented milk.

15. The method according to claim 9 wherein the milk product is selected from soft cheeses, uncooked pressed cheeses, cooked cheeses, processed cheese, cottage cheese, yogurt, matured cream, milk drinks, milk by-products and baby milk.

16. The method according to claim 9 wherein the milk product is cheddar.
